(19) United States
(12) Patent Application Publication
(10) Pub. No.: US 2007/0090126 A1
(43) Pub. Date: Apr. 26, 2007

(54) Liquid material discharge apparatus and liquid material discharge method

(75) Inventors: Koji Tanaka, Tokyo (JP); Kazuo Yamazaki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: TDK Corporation, Tokyo (JP)

(21) Appl. No.: 11/489,730

(22) Filed: Jul. 20, 2006

(30) Foreign Application Priority Data
Jul. 29, 2005 (JP) 2005-220019

(51) Int. Cl. B67D 5/06; B67D 5/38

(52) U.S. Cl. 222/23

(57) ABSTRACT

A liquid material discharge apparatus includes a syringe having a nozzle for discharging a liquid material, and a pressure control section for controlling pressure to be applied inside the syringe by means of a pressure medium and/or a pressure applying time period. The apparatus further includes an imaging device for imaging the shape of a liquid material discharged from the nozzle of the syringe, and an image processing section for calculating the length between a lower end of the liquid material and a reference position of the nozzle on the basis of the imaged shape of the liquid material. The pressure control section controls the pressure to be applied by the pressure medium and/or the pressure applying time period on the basis of the length between the lower end of the liquid material and the reference position that is calculated.

### BACKGROUND OF THE INVENTION

1. Field of the invention

The present invention relates to an apparatus and a method for discharging/coating/injecting/filling/dripping a liquid material including a viscous fluid such as a paste material or an adhesive, onto/into/in/to an object. More particularly, the present invention relates to apparatus and a method that enable an amount of the liquid material discharged from discharging means for liquid material (for example, a syringe having a discharging part for the liquid material) to be measured and controlled and are intended to discharge/coat/inject/fill/drip a certain amount of liquid onto/into/in/to an object (hereinafter simply referred to as “liquid material discharge apparatus and a liquid material discharge method”).

2. Description of the Prior Art

Generally, an apparatus having a dispenser is used for liquid material discharge such as apparatus used in the manufacturing process of electronic parts and intended to discharge and coat a predetermined liquid material onto an object. As shown in FIG. 6, a dispenser 50 is comprised of a syringe 51 for containing a liquid material 60 therein, a tube 52 for supplying compressed air to the syringe, a pressure control section 53 for controlling the pressure of the compressed air, a temperature sensor 54 for detecting the temperature of the liquid material, and a temperature control section 55 for controlling the temperature.

In the dispenser 50, the volume of the liquid material to be discharged is controlled by controlling both the magnitude of the pressure to be applied to the liquid material 60 via the compressed air and an applying time of the pressure. Generally, the inside of the syringe 51 is connected to an external compressed air source 61 having a predetermined pressure through the tube 52 and a valve 56 provided inside the pressure control section 53. Based on the time period between opening and closing the valve 56, the pressure applying time is controlled. Further, a pressure regulator 57 is placed between the valve 56 and the syringe 51, and the magnitude of the pressure applied to the inside of the syringe 51 is controlled by means of the pressure regulator 57.

Also, liquid materials such as resins have viscosities that significantly vary depending on the holding temperature of the material, and therefore the volume of the liquid material discharged by the application of pressure also significantly varies. Accordingly, in order to keep constant the discharge amount from the dispenser 50, the temperatures of the inside of the syringe 51 and the discharging part should be kept constant. The temperature of the inside of the syringe 51 or the like is maintained constant temperature by the temperature sensor 54, the temperature control section 55, and the temperature control device 58.

Note that a discharge pressure applied to a liquid material present at the opening in the lower end of the syringe 51 is comprised of pressure applied by the compressed air and pressure applied by the weight of the liquid material inside the syringe 51. In order to discharge a liquid material having a constant volume, a constant discharge pressure must be applied to the liquid material present at the opening. Accordingly, in the case where the liquid material is reduced by a certain amount and hence the total weight of the liquid material inside the syringe 51 is reduced, an increase in pressure corresponding to the reduction in weight must be added (hydraulic head difference).

Note, however, that there exists the physical-property by which a given volume of air will elastically shrink according to the magnitude of pressure applied to it. The volume shrinkage furthermore occurs over a certain elapsed time period from the point at which pressure is applied. For this reason, if the total pressure is simply increased by adding just the magnitude of the pressure corresponding to the reduction in the liquid material, a predetermined pressure may not actually be applied at the syringe opening, and thereby the volume discharged from the dispenser 50 may be different from an assumed value.

In a conventional technology, a relationship between a remaining amount of the liquid material in the syringe 51 and a pressure of supply air with regard to a discharge volume is preliminarily obtained for various liquid materials, and a pressure correction coefficient for keeping constant the discharge volume is obtained based on the relationship. Then, controlling the pressure of the air as needed in accordance with the correction coefficient enables a certain amount of liquid material to be discharged (correction for hydraulic head difference).

Also, the correction coefficients are preliminarily obtained in relation to various temperature ranges, i.e., various viscosities in various liquid materials, and used for stabilizing an actual discharge volume.

The other method for controlling the actual discharge volume includes a method in which immediately before an actual discharge process, a liquid material actually discharged is weighed on a precision weighing scale (not shown) and a discharge volume is measured on the basis of the weight. In this case, an actual discharge volume is measured every few times a discharge operation is performed, and a pressure and a pressure applying time are controlled on the basis of the measurement result to thereby stabilize the actual discharge volume.

Problem 1 to be Solved in Conventional Technology

Specific applications of liquid material discharge apparatus include, for example, a case where in order to bond chip-type electronic parts onto a print circuit board with an adhesive resin, the adhesive resin is coated like points on a surface of the print circuit board. In such a case, because the miniaturization of the chip-type electronic part to be assembled on the print circuit board or the like has been prominent in recent years, an actual discharge amount required for one discharge process of a liquid material becomes a minute amount and a small variation in the amount is also required, i.e., the actual discharge volume has been requiring increasingly higher accuracy in recent years. Specifically, it has conventionally been only necessary to control accuracy of the order of 0.1 mg in weight, whereas currently, an actual discharge volume is around 0.2 mg and the actual discharge volume is requiring to be controlled with accuracy of ±7% or less (±0.014 mg or less). However, the correction for the hydraulic head difference is practiced by a method for adjusting a pressure and a pressure applying time on the basis of a correction coefficient preliminarily obtained, and a discharge volume at the time of an actual injection is not checked. Accordingly, if a condition under which the correction coefficient is obtained, for example, a viscosity of a liquid material inside a syringe is different, an actual discharge volume may differ.

Also, a method in which the weight of a liquid material actually discharged is measured and a pressure control or the like is performed on the basis of the measured value can respond to the current accuracy by improving the accuracy of a weighing scale. However, in this case, there may cause a problem that weighing the variation of 0.014 mg or less actually takes a lot of time. Further, if such high accuracy is required, a cost of liquid material discharge apparatus including such a weighing scale must be increased. Also, a discharge volume at the time of weighing and a discharge volume in a real process may be different from each other.

Problem 2 to be Solved in Conventional Technology

Further, there exists another problem in conventional liquid material discharge apparatus. In the case where the liquid material discharge apparatus has not been activated for a predetermined time period such as a time period for a lot change, a coating amount (i.e. discharge volume) immediately after reactivation of the apparatus becomes unstable. For example, as shown in FIG. 7, a phenomenon such as an increase in the first coating amount in previous lot or a decrease in the first coating amount in current lot occurs. The phenomenon is caused by a variation in a compressed air condition in a syringe, a variation in viscosity of a liquid due to temperature change or volatilization of a solvent, or the like, and cannot be solved by the correction for the hydraulic head difference. For this reason, an initial discharge generally called as “wasted discharge” is performed at another position for stabilization; however, expensive liquid has to be discarded, and also regarding to how to dispose of the discarded liquid, an increase in the number of process steps should be prepared.

Prior arts that have been made in consideration of such Problems 1 and 2 and are intended to control a discharge amount of a liquid material with high accuracy include Japanese Patent Application Laid-Open No. 2001-327905, Japanese Utility Model application Laid-Open No. 63-115470, and Japanese Patent Application Laid-Open No. 2000-167462.

These documents disclose a method wherein in apparatus for discharging a liquid material by applying pressure to a syringe containing the liquid material, a shape of the liquid material discharged from a discharging port of a syringe is imaged by a camera, then the volume of the material is obtained from the imaged shape, and a pressure to be applied to the syringe and a corresponding applying time are controlled on the basis of the obtained volume.

Also, regarding to how to obtain the volume of the discharged liquid material, Japanese Patent Application Laid-Open No. 2001-327905 discloses a method for obtaining the volume of a droplet that is formed from a liquid material at a lower open end of a cylinder that extends in a vertical direction and has the liquid material flowing therein. In the method, images of the cylinder and the droplet are taken in a horizontal direction, then, based on the number of disks each of which has a minute thickness and a diameter that is a distance between two intersections at which a silhouette line of the images and a horizontal line intersect with each other, the volume of each of the disks existing between a predetermined position separated upwardly from the lower end of the cylinder and a lower end of the droplet is integrated, and a volume between the lower end of the cylinder and the predetermined position is subtracted from the integrated volume.

Japanese Utility Model Application Laid-Open No. 63-115470 describes that a volume L can be deduced with reference to FIG. 2 in the document from the following expression (1) in the document:

$$L = {\int }^{K} {π ( di / 2 )}^{2} ⅆ t$$

Japanese Patent Application Laid-Open No. 2000-167462 describes that a measurement of a coating amount by image processing can also be performed by the calculation of the volume of a sphere on the basis of its diameter, and therefore a calculation becomes simple.

The methods in the prior arts have enabled “Problem 2 to be solved in conventional technology” to be solved. However, regarding to “Problem 1 to be solved in conventional technology”, there remains the following problem. The remaining problem is hereinafter described.

A liquid material discharged from a nozzle (or also referred to as a needle), which is used as a discharging part, of a syringe having a discharging port at its lower end normally stays as a droplet 20 at a tip of the nozzle 32 in a gravitational direction due to surface tension as shown in FIG. 8A. However, in the case where surplus liquid is attached to a side face of the nozzle 32, or the like, the droplet 20 may be moved up to the side face of the nozzle 32 due to the surplus liquid as shown in FIG. 8B. In either case of FIG. 8A or FIG. 8B, if the discharged droplet 20 is imaged by a camera to obtain its volume, the volume is determined substantially the same as the other; however, a lowering distance (a stroke) of the nozzle 32 is a constant amount, and therefore the droplet 20 in FIG. 8A comes into contact with a substrate 11, which is a coating object, and the liquid material moves to the substrate 11 from the nozzle 32 and is coated. However, in the case of FIG. 8B, there has caused a problem that even when the nozzle stroke is at the lowest point, the droplet 20 does not come into contact with the substrate 11, and the substrate 11 is not coated thereon with the liquid material.

### SUMMARY OF THE INVENTION

The present invention has been made in consideration of the above points, and therefore an object of the present invention to provide a liquid material discharge apparatus and a liquid material discharge method that are capable of stably coating a certain amount of liquid material onto an object without a measurement of the volume of the liquid material discharged from a discharging part and an occurrence of a failure in coating.

Other objects and new features of the present invention will be clarified in an embodiment section to be described later.

In at least one embodiment of the present invention, a liquid material discharge apparatus comprises: a syringe containing a liquid material therein and having a discharging part for discharging the liquid material; a pressure control section for controlling a value of pressure to be applied to the inside of the syringe by means of a pressure medium and/or an applying time period of the pressure; an imaging device for imaging a shape of the liquid material discharged from the discharging part of the syringe at the time of discharge of the liquid material; and an image processing section for calculating a length between a lower end of the liquid material and a reference position of the discharging part on the basis of the imaged shape of the liquid material; wherein the pressure control section controls the value of the pressure to be applied by means of the pressure medium and/or the applying time period of the pressure on the basis of the calculated length between the lower end of the liquid material and the reference position.

According to this aspect of the invention, the liquid material discharge apparatus further comprises a storage section for storing the length between the lower end of the liquid material and the reference position, the length being calculated by the image processing section; and a comparison section for comparing the length stored in the storage section with a new length calculated by the image processing section to obtain a difference therebetween, wherein the pressure control section performs the control on the basis of the difference obtained by the comparison section.

Another aspect of the invention provides the liquid material discharge apparatus wherein the value of the pressure is at least any one of positive pressure and negative pressure.

Another aspect of the invention provides a liquid material discharge apparatus comprising: a discharging part for discharging a liquid material; an imaging device for imaging a shape of the liquid material discharged from the discharging part at the time of discharge of the liquid material; and an image processing section for calculating a length between a lower end of the liquid material and a reference position of the discharging part on the basis of the imaged shape of the liquid material; wherein the length (L) to be calculated between the lower end of the liquid material and the reference position is controlled to be an appropriate value in relation to a known distance (D) from the reference position to a object and a known stroke (S) of the discharging part.

Another aspect of the invention provides the liquid material discharge apparatus wherein an illumination device for illuminating the liquid material with light is provided at a position opposed to the imaging device across the liquid material discharged from the discharging part, and the imaging device takes an image of the liquid material so that the image is formed by transmission light.

Another aspect of the invention provides a liquid material discharge method, comprising the steps of: discharging a liquid material from a discharging part provided for a syringe containing the material therein; controlling a value of pressure to be applied to the inside of the syringe by means of a pressure medium and/or an applying time period of the pressure by a pressure control section; and imaging the liquid material discharged from the discharging part by an imaging device while the liquid material is held at the discharging part as a droplet, and calculating a length between a lower end of the droplet and a reference position of the discharging part on the basis of the imaged shape of the droplet; wherein the pressure control section controls the value of pressure to be applied to the liquid material contained in the syringe and/or the applying time period of the pressure on the basis of the calculated length between the lower end of the droplet and the reference position while the droplet is held at the discharging part.

Another aspect of the invention provides the liquid material discharge method wherein the value of the pressure is at least any one of positive pressure and negative pressure.

Another aspect of the invention provides a liquid material discharge method, comprising the steps of: discharging a liquid material from a discharging part provided for a syringe containing the material therein; applying a value of pressure by means of a pressure medium to the liquid material contained inside of the syringe so as to discharge the liquid material from the discharging part; imaging the liquid material discharged from the discharging part by an imaging device, and calculating a length between a lower end of the liquid material and a reference position of the discharging part on the basis of the imaged shape of the liquid material; and controlling the length (L) to be calculated between the lower end of the liquid material and the reference position, so that the length (L) is determined to be an appropriate value in relation to a known distance (D) from the reference position to a object and a known stroke (S) of the discharging part.

### BRIEF DESCRIPTION OF THE DRAWINGS

FIG. 1 is a schematic block diagram illustrating an embodiment of a liquid material discharge apparatus and a liquid material discharge method according to the present invention.

FIG. 2 is a perspective view illustrating an appearance of the embodiment.

FIG. 3 is an elevational view illustrating an essential configuration of the embodiment.

FIG. 4A is intended to explain a principle of control of a liquid material discharge amount and an elevational view illustrating the case where a normal droplet is formed, FIG. 4B is an elevational view illustrating the case where a droplet moved up to a side face of a nozzle due to liquid attached to the side face of the nozzle is formed, FIG. 4C is an elevational view illustrating the case where in addition to a droplet left at the time of previous discharge, new discharge of a liquid material is performed, and FIG. 4D is an elevational view illustrating the case where a large amount of droplet is dropped onto a substrate, causing a defective substrate.

FIG. 5A is an elevational view illustrating the step 1 of a series of coating steps according to the embodiment, FIG. 5B is an elevational view illustrating the step 2, FIG. 5C is an elevational view illustrating the step 3, FIG. 5D is an elevational view illustrating the case where only a reference amount of liquid material is coated in the step 4, and FIG. 5E is an elevational view illustrating the case where in addition to the reference amount, a specified amount is further coated in the step 4.

FIG. 6 is a general schematic block diagram of a dispenser having a syringe.

FIG. 7 is an explanatory diagram illustrating a relationship between the number of coatings and a coating amount, in which it is shown that the coating amounts immediately after reactivation are unstable.

FIG. 8A is an elevational view illustrating the case where a normal droplet is formed, although even in the case of a droplet having substantially the same volume, sometimes the droplet can be coated, but the other times it cannot be coated, and FIG. 8B is an elevational view illustrating the case where a droplet moved up to a side face of a nozzle due to liquid attached to the side face of the nozzle is formed.

### DETAILED DESCRIPTION OF THE INVENTION

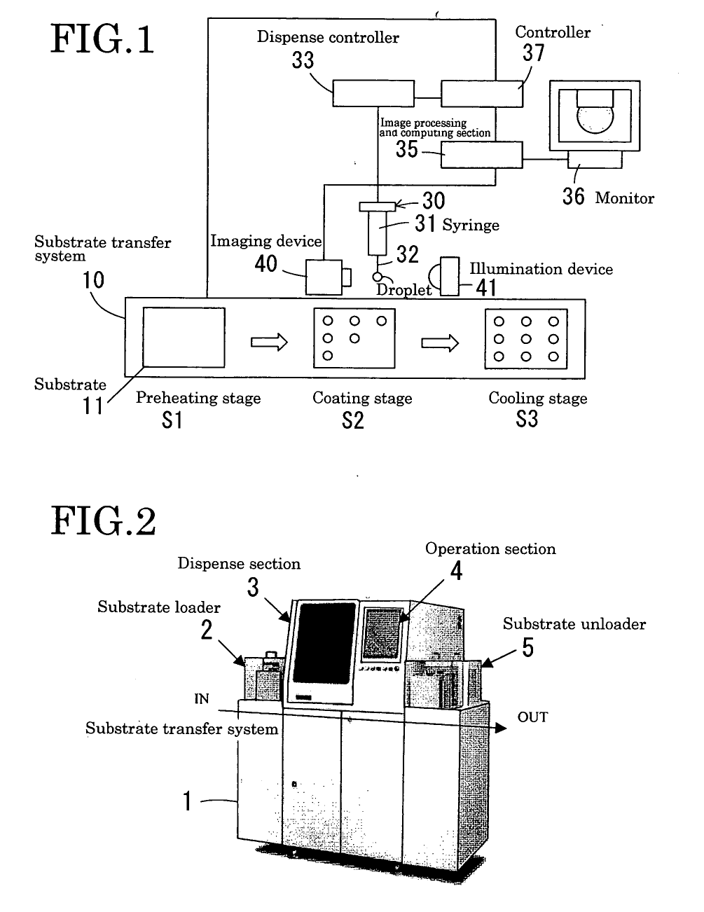

An embodiment of the liquid material discharge apparatus and the liquid material discharge method according to the present invention is described in reference to FIGS. 1 to 5. First, to describe an overall configuration, as shown in FIG. 2, the liquid material discharge apparatus has an apparatus frame 1 provided thereon with a substrate loader 2, a dispense section 3, an operation panel 4, and a substrate unloader 5. The dispense section 3 is a part for coating a liquid material (various resins, etc) onto a substrate, which is a coating object, with a dispenser. The substrate loader 2 is intended to supply the substrate to the dispense section 3, and the substrate unloader 5 is intended to unload the substrate onto which the liquid material has been coated in the dispense section 3.

An essential configuration of the liquid material discharge apparatus is a combination of a substrate transfer system, an imaging device (a camera or the like), and a dispenser, and the substrate transfer system has at least one stage. In the example of FIG. 1, a substrate transfer system 10 has three stages comprised of a preheating stage S1, a coating (dispensing) stage S2, and a cooling stage S2. A substrate 11 is adapted to be supplied to the substrate transfer system 10 from the substrate loader 2 shown in FIG. 2, sequentially transferred from the preheating stage S1 to the coating stage S2 and further to the cooling stage S3, and then unloaded from the substrate transfer system 10 by the substrate unloader 5.

In the case of necessity of preheating the substrate 11 before liquid coating, the preheating stage S1 raises the temperature of the substrate 11 by preheating means such as a heater to thereby function to increase fluidity during liquid coating on the coating stage S2.

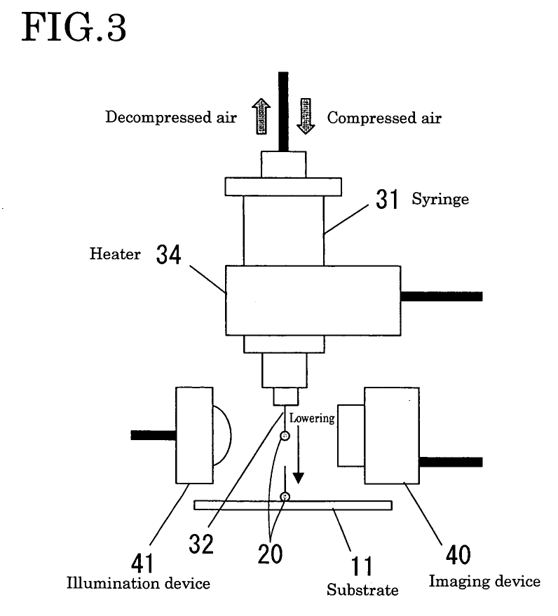

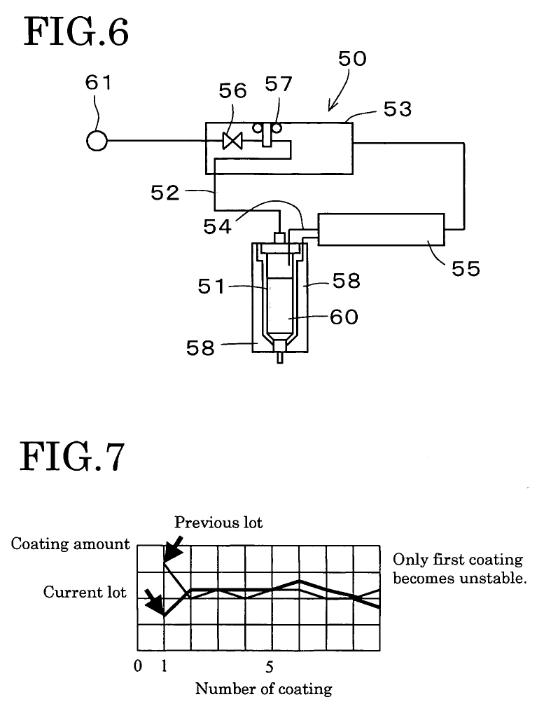

The structure itself of the dispenser 30 for coating liquid onto the substrate 11 on the coating stage S2 is well known (e.g., see the conventional technology in FIG. 6), and has a syringe 31 holding (containing) the liquid material inside and having a discharging part for discharging the liquid material. The discharging part of the syringe 31 is comprised of a nozzle (needle) 32 integrally provided at the lower end of the syringe 31, and the lower open end of the nozzle 32 is a discharging port. The syringe 31 is configured to extrude an appropriate amount of the liquid material to thereby discharge the liquid material from the lower end of the nozzle 32. The discharge amount of the liquid material, i.e., the coating amount of the liquid material is controlled by a dispense controller 33 to which the dispenser 30 is connected. The dispense controller 33 has a pressure control section for controlling at least one of a value of pressure to be applied to the inside of the syringe 31 by the use of a pressure medium (compressed air or decompressed air) or the application time period of the pressure. It also separately has a temperature control section (not shown) for activating a heater 34, which is provided around the syringe 31 shown in FIG. 3 and functions as a temperature control device, to thereby control temperature of the liquid material inside the syringe. On the coating stage S2, an operation of coating the liquid (droplet) at one position or several positions on the substrate 11 in the shape of, for example, a point or a line is performed.

The cooling stage S3 operates to lower the temperature of the substrate 11 having been raised on the coating stage S2, and solidifies and stabilizes the coated liquid.

As shown in FIG. 3, on the coating stage S2, an imaging device 40 and an illumination device 41 are placed at positions opposed to each other across a droplet 20, which is the liquid material discharged from the nozzle 32. The imaging device 40 is a CCD camera or the like, and the illumination device 41 is intended to emit transmission light directed to the imaging device 40. The imaging device 40 takes an image of the droplet 20 (an image in which the droplet is gloomily caught), which is formed by the transmission light. Also, as shown in FIG. 1, an image processing and computing section 35 for processing a signal of the image taken by the imaging device 40 and a monitor 36 for displaying a processed result are provided. Further, a controller 37 for performing a feedback control of the dispense controller 33 on the basis of the image-processed result (details of the process will be described later) from the image processing and computing section 35 is provided. In addition, the controller 37 performs various controls for the entire apparatus.

Also, in the case where the coating stage S2 has a function as an X-Y table that is movable forward, backward, leftward, and rightward in a horizontal plane along orthogonal two axes, it is only necessary for the dispenser 30 to move along a Z-axis (upward and downward). In the case where the coating stage S2 has a function of locating and holding the substrate 11, but does not has a function as the X-Y table, the dispenser 30 should have a function of moving along X, Y and Z axes (along orthogonal three axes).

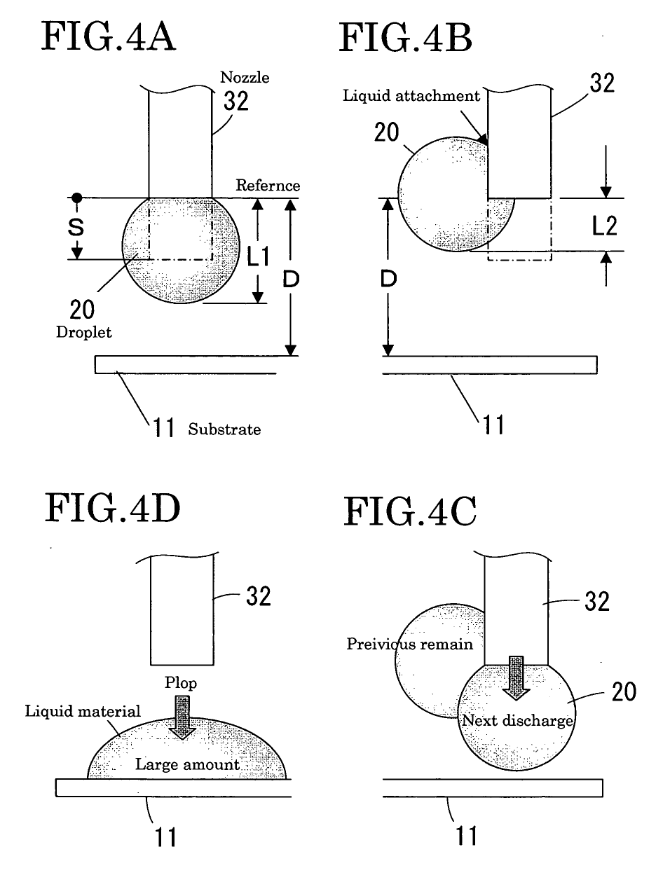

A principle of control of a liquid material discharge amount in accordance with image processing in the liquid material discharge apparatus of the embodiment is described in reference to FIG. 4.

(a) The liquid material having been discharged from the nozzle 32 integrally provided at the lower part of the syringe 31 is imaged while being held at the nozzle 32 as a droplet 20, and based on an imaged shape of the droplet 20, a length L between the lower end of the droplet 20 and the reference position of the nozzle 32 (the lower end of the nozzle in the case of FIG. 4) is measured and calculated. In other words, based on the signal of the image, in which the shape of the droplet 20 is caught with the imaging device, the length L from the reference position present on a nozzle side to the lowest point of the droplet 20 is calculated.

Then, it is calculated whether a relationship between the predefined lowering stroke S of the nozzle 32 and the distance D between the nozzle 32 at an elevated position and the substrate 11 satisfies the following expression (1) or not (for example, by a computation with the controller 37). The satisfaction of the expression (1) enables the droplet 20 to be determined to surely come into contact with the substrate 11 (prevention of miss contact).
(D−L)<S (1)

(b) Also, setting a threshold to the size of the length L is able to check whether a substantially necessary amount of droplet is discharged. In other words, a control is performed such that the length L satisfies the expression (1) and/or does not exceed the threshold.

In the example of FIG. 4 A, the length L equals to L1 (L=L1), and satisfies the expression (1) in the above article (a), and a size of the length L in the article (b) falls within the threshold or less. Accordingly, a normal coating operation can be expected. On the other hand, in the example of FIG. 4B, due to an attachment of surplus liquid to the side face of the nozzle, or the like, the droplet 20 has been moved up in a direction of the side face by the surplus liquid. For this reason, even if the volume of the droplet in the case of FIG. 4B is substantially the same as that in the case of FIG. 4A, the length L equals to L2 (L=L2) and does not satisfy the expression (1) in the article (a). In this case, if a coating operation is performed, a miss contact (failure in coating onto the substrate) occurs, and therefore measures should be provided in such a way that a size of the droplet 20 is increased until the expression (1) is satisfied, or the apparatus is deactivated and then the nozzle 32 is cleaned (to remove the attachment of surplus liquid to the side face of the nozzle), or the like.

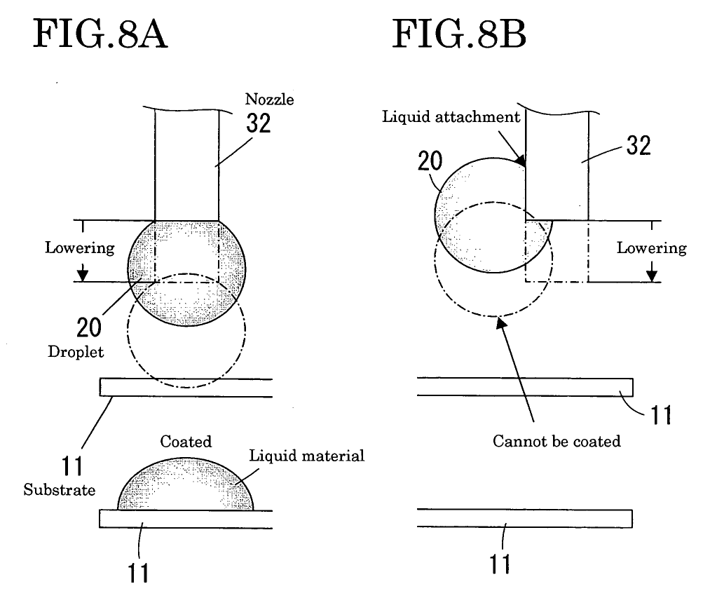

The above article (a) is effective for the prevention of the failure described in reference to FIG. 8B in liquid coating onto the substrate 11. Also, in the case of FIG. 8B, in the conventional apparatus, without liquid coating onto the substrate 11, a specified amount of liquid material for the next coating operation is discharged from the tip of the nozzle as shown in FIG. 4C, and therefore, in the coating operation following the failure in coating, an excess of the liquid material causes dropping of the liquid material as shown in FIG. 4D, causing a defective substrate. However, the embodiment is adapted to prevent the dropping of the liquid material from occurring.

The article (b) is effective for measures for the wasted discharge, i.e., measures for an abnormal discharge amount (measures for instability of a coating amount immediately after the reactivation). A liquid material used with a dispenser usually has surface tension that can become appropriate by a temperature control or the like, and therefore if a same amount is discharged, a stable length L is obtained, and in case of anomaly detection, it is not necessary to accurately obtain the volume of the droplet 20 by complex calculation. Further, for practical purposes, because a computation is simple, a favorable effect is slightly provided on operation tact time.

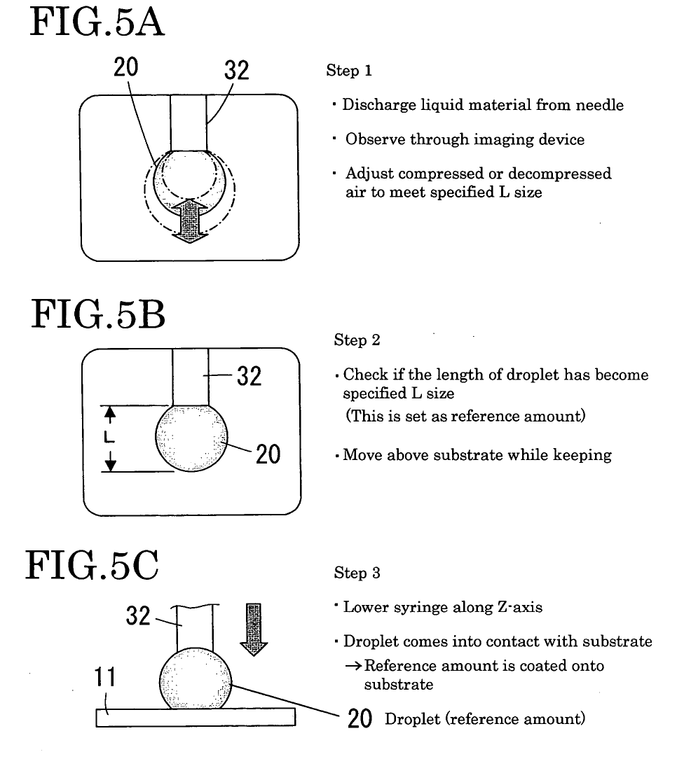

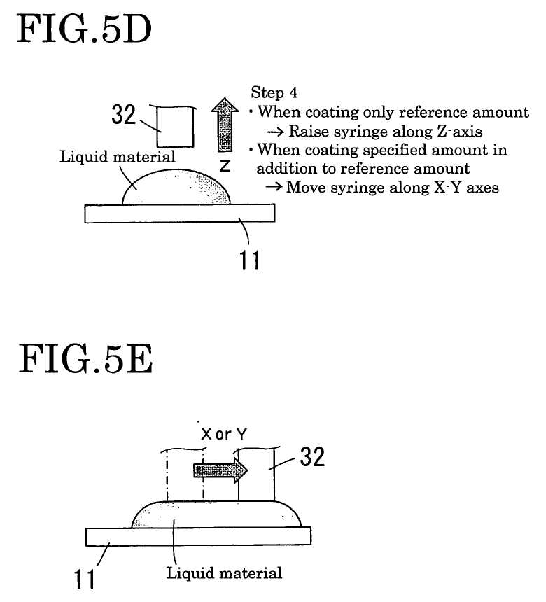

FIG. 5A-FIG. 5B illustrates a series of coating steps in the liquid material discharge apparatus according to this embodiment. In the step 1 of FIG. 5A, the liquid material is discharged from the nozzle 32 and then imaged by the imaging device 40 while being held at the lower end of the nozzle 32 as the droplet 20. Based on an imaged shape of the droplet 20, the length L between a lower end of the droplet and a reference position (the lower end) of the nozzle 32 is calculated in the image processing and computing section 35. Then, the dispense controller 33 is controlled by the controller 37, and a value of air pressure (supplied by switching between compressed air and decompressed air) to be applied as a pressure medium and/or a pressure applying time period is adjusted in the pressure control section of the dispense controller 33 such that the calculated length L becomes a specified size (L satisfies the expression (1) in the above article (a) and becomes a size within the threshold described in the article (b)).

In the step 2 of FIG. 5B, it is checked by the above image processing that the length of the droplet 20 in a vertical direction has become a size of the specified length L (an amount of the droplet 20 at this time is defined as a reference amount), and then the droplet 20 is moved above the substrate 11, which is a coating object, while this condition of the droplet 20 is kept.

In the step 3 of FIG. 5C, the syringe 31 (also the nozzle 32) is lowered at a predetermined stroke along the Z-axis to bring the droplet 20 in contact with the substrate 11. As a result, the reference amount of liquid material is adhered and coated onto the substrate 11.

In the step 4, in the case of coating only in the reference amount, the syringe 31 is raised along the Z-axis to be returned as shown in FIG. 5D. Also, in the case of coating in the specified amount in addition to the reference amount, the syringe 31 is moved along the X-Y directions as shown in FIG. 5E (the substrate 11 may be relatively moved along the X-Y directions). This allows coating to be performed in a line shape.

According to the embodiment following effects are obtained.

(1) A shape of the liquid material at the time of discharge of the liquid material discharged from the nozzle 32 of the syringe 31 is imaged with the imaging device 40, a length L between a lower end of the liquid material and a reference position of the nozzle 32 is calculated in the image processing and computing section 35 on the basis of the imaged shape of the liquid material, and the pressure control section built in the dispense controller 33 controls a value of pressure to be applied by means of a pressure medium and/or an applying time period of the pressure on the basis of the calculated length L between the lower end of the liquid material and the reference position. Therefore it is prevented from occurring that the liquid material is not coated onto the substrate 11 as a coating object at the time of an coating operation of the liquid material onto the substrate 11, and the variation in a discharge amount of the liquid material enable to be reduced, whereby the liquid material can be stably coated onto the substrate 11.

(2) The calculation of the length L between the lower end of the liquid material discharged from the nozzle 32 and the reference position of the nozzle 32 is easier in comparison with that of the volume of the liquid material in terms of computation, and can be rapidly performed.

(3) The illumination device 41 for illuminating the liquid material with light is provided at a position opposed to the imaging device 40 across the liquid material discharged from the nozzle 32, and emitting transmission light from the illumination device 41 toward the imaging device 40 enables an image of the liquid material (an image in which the liquid material is caught as a silhouette) formed by the transmission light to be accurately and clearly taken with the imaging device 40.

In addition, in the case of repeatedly performing the control of a discharge amount of the liquid material shown in FIG. 5, it may be configured such that the controller 37 is provided with a storage section for storing the length L between the lower end of the droplet 20 and the reference position of the nozzle 32, which is calculated by the image processing and computing section 35, and a comparison section for comparing the length stored in the storage section with a new length calculated by the image processing section 35 to obtain the difference therebetween, so that the pressure control section in the dispense controller 33 performs a control of the dispenser 30 (control of a value of pressure and/or an applying time period of the pressure) on the basis of the difference obtained by the comparison section.

Although the embodiment of the present invention has been described above, the present invention is not limited thereto and it will be self-evident to those skilled in the art that various modifications and changes may be made without departing from the scope of claims.

As described above, the liquid material discharge apparatus and the liquid material discharge method according to the present invention are adapted to focus attention on a length between a lower end of a liquid material discharged from a discharging part and a reference position of the discharging part to detect and control a discharge amount of the liquid material, so that it is prevented from occurring that the liquid material is not coated onto an object such as a substrate at the time of an coating operation of the liquid material onto the object, and the liquid material can be stably coated onto the object with a reduced variation in discharge amount of the liquid material. Also, a calculation of the length between the lower end of the liquid material discharged from the discharging part and the reference position of the discharging part is easier in comparison with that of the volume of the liquid material and can be rapidly performed.

1. A liquid material discharge apparatus comprising:
a syringe containing a liquid material and having a discharging part for discharging the liquid material;
a pressure control section for controlling pressure to be applied to the syringe by a pressure medium and, optionally, an applying time period of applying the pressure;
an imaging device for imaging shape of the liquid material discharged from the discharging part of the syringe upon discharge of the liquid material; and
an image processing section for calculating length between a lower end of the liquid material and a reference position of the discharging part based on the shape of the liquid material imaged by the imaging device, wherein the pressure control section controls the pressure to be applied by the pressure medium and, optionally, the applying time period of applying the pressure based on the length between the lower end of the liquid material and the reference position that is calculated by the image processing section.

2. The liquid material discharge apparatus according to claim 1, comprising:
a storage section for storing the length between the lower end of the liquid material and the reference position calculated by the image processing section; and
a comparison section for comparing the length stored in the storage section with a new length calculated by the image processing section to obtain a difference therebetween, wherein the pressure control section controls the pressure based on the difference obtained by the comparison section.

3. The liquid material discharge apparatus according to claim 1, wherein the pressure is at least one of positive pressure and negative pressure.

4. A liquid material discharge apparatus comprising:
a discharging part for discharging a liquid material;
an imaging device for imaging shape of the liquid material discharged from the discharging part upon discharge of the liquid material; and
an image processing section for calculating length between a lower end of the liquid material and a reference position of the discharging part based on shape of the liquid material imaged by the imaging device, wherein the length between the lower end of the liquid material and the reference position is controlled to be an appropriate value in relation to a known distance from the reference position to an object and a known stroke of the discharging part.

5. The liquid material discharge apparatus according to claim 4, including an illumination device for illuminating the liquid material with light, located at a position opposed to the imaging device, across the liquid material discharged from the discharging part, the imaging device forming an image of the liquid material using transmitted light.

6. A liquid material discharge method, comprising:
discharging a liquid material from a discharging part of a syringe containing the material;
controlling a value of pressure to be applied to the syringe by a pressure medium and, optionally, an applying time period of applying the pressure
imaging the liquid material discharged from the discharging part, while the liquid material is held at the discharging part as a droplet;
calculating length between a lower end of the droplet and a reference position of the discharging part based on the droplet imaged; and
controlling the pressure to be applied to the liquid material contained in the syringe and, optionally, the applying time period of applying the pressure based on the length between the lower end of the droplet and the reference position, while the droplet is held at the discharging part.

7. The liquid material discharge method according to claim 6, wherein the pressure is at least one of positive pressure and negative pressure.

8. A liquid material discharge method, comprising:
discharging a liquid material from a discharging part of a syringe containing the material;
applying pressure by a pressure medium to the liquid material contained inside of the syringe to discharge the liquid material from the discharging part;
imaging the liquid material discharged from the discharging part;
calculating length between a lower end of the liquid material and a reference position of the discharging part, based on the liquid material imaged; and
controlling the length between the lower end of the liquid material and the reference position, so that the length is an appropriate value in relation to a known distance from the reference position to an object and a known stroke of the discharging part.
